(19) United States
(12) Patent Application Publication
(10) Pub. No.: US 2018/0053131 A1
(43) Pub. Date: Feb. 22, 2018

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Jiali GU, Kanagawa (JP)

(73) Assignee: FUJI XEROX CO., LTD., Tokyo (JP)

(21) Appl. No.: 15/497,687

(22) Filed: Apr. 26, 2017

(30) Foreign Application Priority Data
Aug. 16, 2016 (JP) 2016-159488

(51) Int. Cl. G06Q 10/06; G06Q 10/10; G06Q 40/00

(52) U.S. Cl. CPC G06Q 10/06313; G06Q 40/125; G06Q 10/103

(57) ABSTRACT

An information processing apparatus includes a designating unit that designates a first function from among plural functions on basis of a user's operation in cases where a history of work of operating one or more business operation systems having the plural functions is accumulated; and a first output unit that outputs information concerning a user who is shown from the history to have experienced work of operating a second function before, the second function being similar to the first function designated from among the plural functions.

### CROSS-REFERENCE TO RELATED APPLICATIONS

This application is based on and claims priority under 35 USC 119 from Japanese Patent Application No. 2016-159488 filed Aug. 16, 2016.

### BACKGROUND

### Technical Field

The present invention relates to an information processing apparatus and a non-transitory computer readable medium.

### SUMMARY

For example, work done by operating a business operation system sometimes includes work that has not done by anyone before because of diversity of business operations, revision of the system, replacement of the system, or the like. When requesting someone to do this work, it is desirable to find a user who is capable of properly carrying out the work.

According to an aspect of the invention, there is provided an information processing apparatus including a designating unit that designates a first function from among plural functions on a basis of a user's operation in a case where a history of work of operating one or more business operation systems having the plural functions is accumulated; and a first output unit that outputs information concerning a user who is shown from the history to have experienced work of operating a second function before, the second function being similar to the first function designated from among the plural functions.

### BRIEF DESCRIPTION OF THE DRAWINGS

An exemplary embodiment of the present invention will be described in detail based on the following figures, wherein:

FIG. 1 illustrates an overall configuration of an information processing system according to an exemplary embodiment;

FIG. 2 illustrates a hardware configuration of a business operation server apparatus;

FIG. 3 illustrates a hardware configuration of a worker terminal;

FIG. 4 illustrates a hardware configuration of a work history server apparatus;

FIG. 5 illustrates a hardware configuration of a work manager terminal;

FIG. 6 illustrates a functional configuration realized by the information processing system;

FIG. 7 illustrates an example of generated history information;

FIG. 8 illustrates an example of accumulated history information;

FIG. 9 illustrates an example of stored business operation system information;

FIG. 10 illustrates an example of a displayed management screen;

FIG. 11 illustrates an example of a compared element table;

FIG. 12 illustrates an example of displayed information concerning a user;

FIG. 13 illustrates an example of a support material table;

FIG. 14 illustrates an example of a displayed business operation screen;

FIG. 15 illustrates an example of an operation procedure of the apparatuses in work request processing;

FIGS. 16A and 16B illustrate an example of output work request information;

FIG. 17 illustrates an example of an operation authority table; and

FIG. 18 illustrates a functional configuration realized by an information processing system according to a modification.

### DETAILED DESCRIPTION

### [1] Exemplary Embodiment

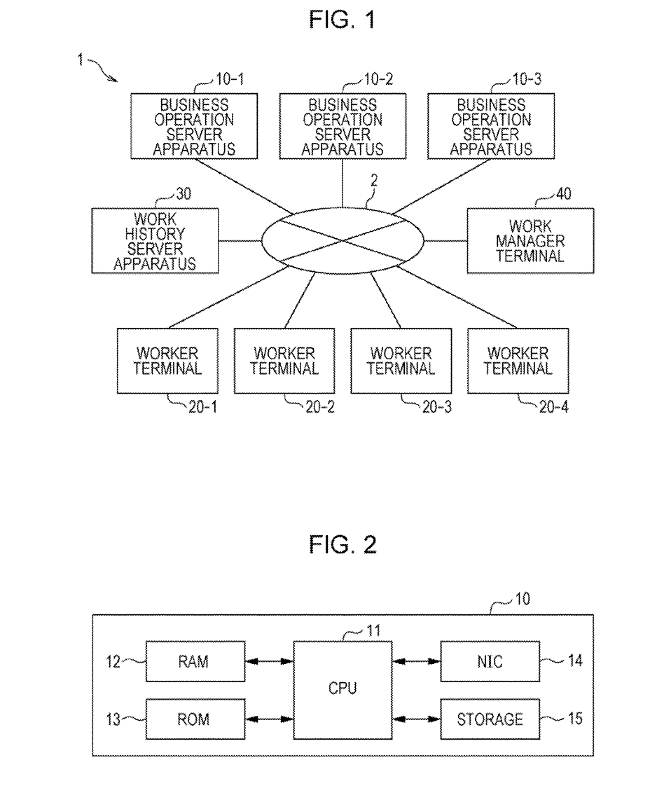

FIG. 1 illustrates an overall configuration of an information processing system 1 according to an exemplary embodiment. The information processing system 1 is a system for information processing concerning plural business operations in a company or the like. The information processing system 1 includes a communication line 2, business operation server apparatuses 10-1, 10-2, and 10-3 (hereinafter sometimes referred to collectively as a “business operation server apparatus 10”), worker terminals 20-1, 20-2, 20-3, and 20-4 (hereinafter sometimes referred to collectively as a “worker terminal 20”), a work history server apparatus 30, and a work manager terminal 40.

The communication line 2 encompasses a mobile communication network, the Internet, and the like and relays exchange of data between apparatuses. The apparatuses included in the information processing system 1 are connected to the communication line 2 by a wire (or wirelessly). The business operation server apparatus 10 is an information processing apparatus that offers functions concerning business operations (e.g., finance, personnel, payroll, purchase, sales, and production) in a company or the like. The worker terminal 20 is a terminal apparatus used by a user (worker) who does work of operating a function offered by the business operation server apparatus 10.

Plural business operation server apparatuses 10 and plural worker terminals 20 work in cooperation. This constructs one or more business operation systems having plural functions. The work history server apparatus 30 accumulates therein a history of work of operating the one or more business operation systems. More specifically, the work history server apparatus 30 accumulates therein a history of work on a document related to a business operation. The document related to a business operation is, for example, a declaration form for year-end tax adjustment used for payroll management work or a purchase order used for sales work.

The work manager terminal 40 is a terminal apparatus used by a user (work manger) who manages work of operating a function offered by the business operation server apparatus 10. This work manager is a person, such as a division manager, a section head, or a group leader, who oversees plural users. As daily work progresses, work needs to be done on various functions of a business operation system. The work manager decides a worker who does the work and requests the worker to do the work. The work manager terminal 40 performs processing for assisting decision of a worker and request of work.

FIG. 2 illustrates a hardware configuration of the business operation server apparatus 10. The business operation server apparatus 10 is a computer that includes a central processing unit (CPU) 11, a random access memory (RAM) 12, a read only memory (ROM) 13, a network interface card (NIC) 14, and a storage 15.

The CPU 11 controls operation of each unit by executing a program stored in the ROM 13 or the storage 15 by using the RAM 12 as a work area. The NIC 14 has a communication circuit for wireless communication compliant with mobile communication and communicates with an external apparatus through the communication line 2. The storage 15 is a storage unit such as a hard disk drive (HDD), a solid state drive (SSD), or a flash memory and stores therein data and a program used for control by the CPU 11.

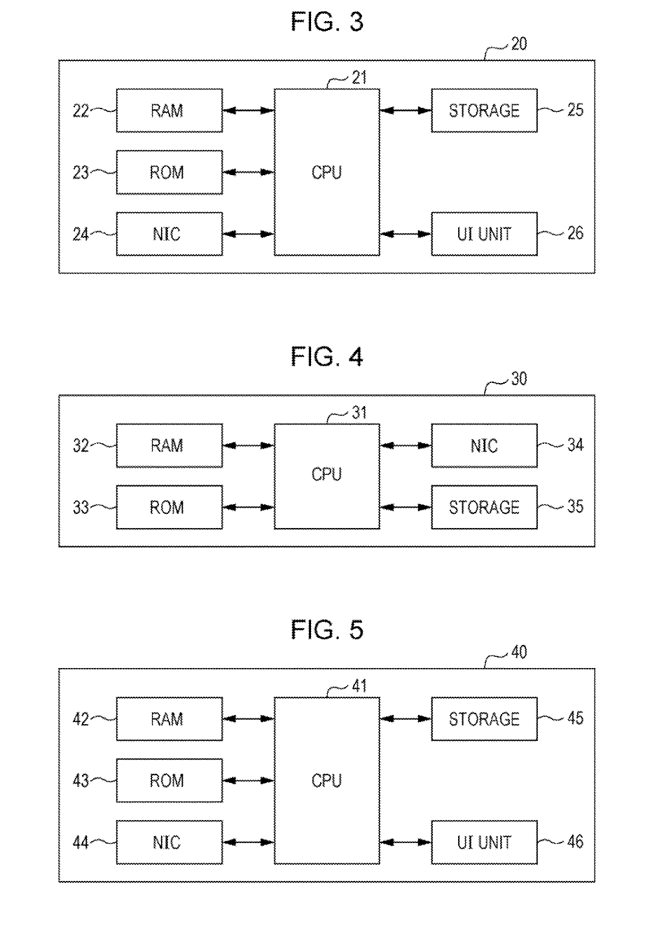

FIG. 3 illustrates a hardware configuration of the worker terminal 20. The worker terminal 20 is a computer that includes a CPU 21, a RAM 22, a ROM 23, an NIC 24, a storage 25, and a UI (User Interface) unit 26. The CPU 21 through the storage 25 are hardware elements that are identical to those given the same names in FIG. 2. The UI unit 26 includes a liquid crystal display and displays, for example, a menu screen for operating the worker terminal 20. Furthermore, the UI unit 26 includes input devices such as a keyboard and a mouse.

FIG. 4 illustrates a hardware configuration of the work history server apparatus 30. The work history server apparatus 30 is a computer that includes a CPU 31, a RAM 32, a ROM 33, an NIC 34, and a storage 35. These elements are hardware elements that are identical to those given the same names in FIG. 2.

FIG. 5 illustrates a hardware configuration of the work manager terminal 40. The work manager terminal 40 is a computer that includes a CPU 41, a RAM 42, a ROM 43, an NIC 44, a storage 45, and a UI unit 46. These elements are hardware elements that are identical to those given the same names in FIG. 3.

The CPU of each apparatus included in the information processing system 1 controls each unit by executing a program, and thus the following functions are realized.

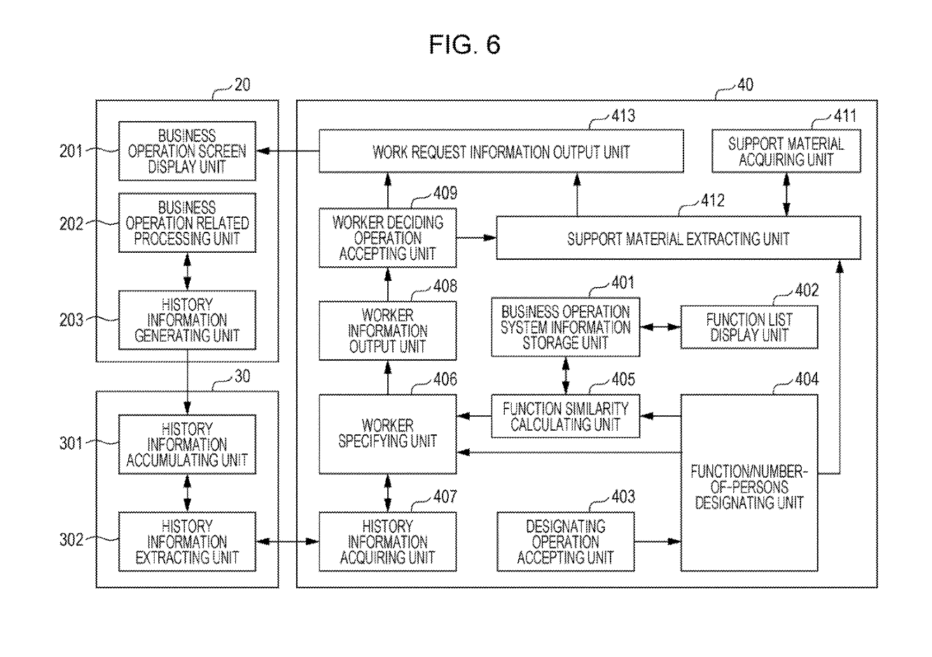

FIG. 6 illustrates a functional configuration realized by the information processing system 1. The worker terminal 20 includes a business operation screen display unit 201, a business operation related processing unit 202, and a history information generating unit 203. The work history server apparatus 30 includes a history information accumulating unit 301 and a history information extracting unit 302. The work manager terminal 40 includes a business operation system information storage unit 401, a function list display unit 402, a designating operation accepting unit 403, a function/number-of-persons designating unit 404, a function similarity calculating unit 405, a worker specifying unit 406, a history information acquiring unit 407, a worker information output unit 408, a worker deciding operation accepting unit 409, a support material acquiring unit 411, a support material extracting unit 412, and a work request information output unit 413.

The business operation screen display unit 201 of the worker terminal 20 displays a business operation screen for carrying out work of operating a function of a business operation system. A user does work by using the displayed business operation screen. The business operation related processing unit 202 executes processing related to a business operation in accordance with a user's operation on the business operation screen. For example, in cases where the user operates an order function, the business operation related processing unit 202 executes processing for generating a purchase order, processing for encrypting the purchase order, processing for transmitting the encrypted purchase order to an external system, and the like on the basis of a user's operation. The business operation related processing unit 202 supplies an operation record (log) during execution of such processing related to a business operation to the history information generating unit 203.

The history information generating unit 203 generates history information indicative of history of work of operating a business operation system on the basis of an operation record supplied from the business operation related processing unit 202.

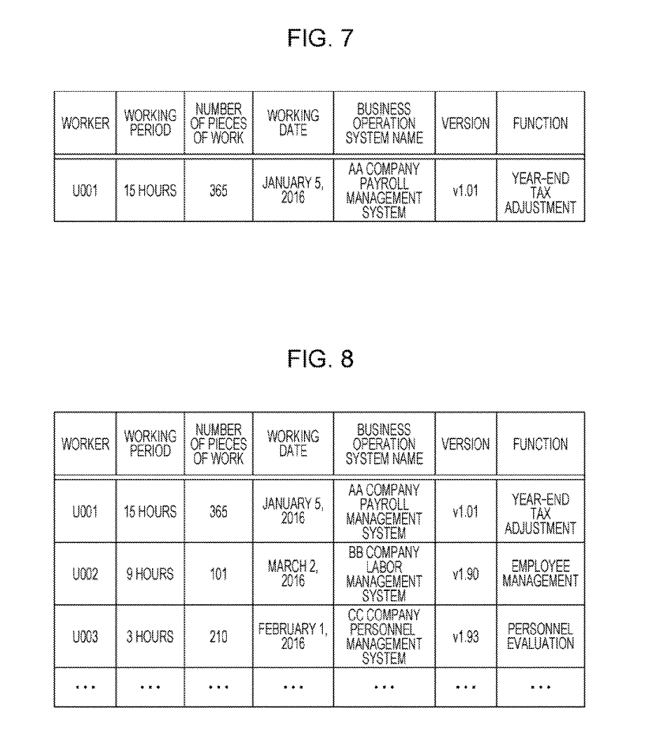

FIG. 7 illustrates an example of the generated history information. In the example of FIG. 7, the history information generating unit 203 generates history information in which a user ID “U001” of a worker, a working period “15 HOURS”, the number of pieces of work “365”, a working date “JANUARY 5, 2016”, a business operation system name “AA COMPANY PAYROLL MANAGEMENT SYSTEM”, a business operation system version “v1.01”, and a function name “YEAR-END TAX ADJUSTMENT” are associated with one another. The history information generating unit 203 transmits the generated history information to the work history server apparatus 30.

The history information accumulating unit 301 of the work history server apparatus 30 accumulates therein the history information transmitted from the worker terminal 20.

FIG. 8 illustrates an example of the accumulated history information. In the example of FIG. 8, history of work done by a worker given a user ID “U002” and history of work done by a worker given a user ID “U003” are accumulated in addition to the history of work done by the worker given the user ID “U001”.

The business operation system information storage unit 401 of the work manager terminal 40 stores therein business operation system information concerning each business operation system of the information processing system 1.

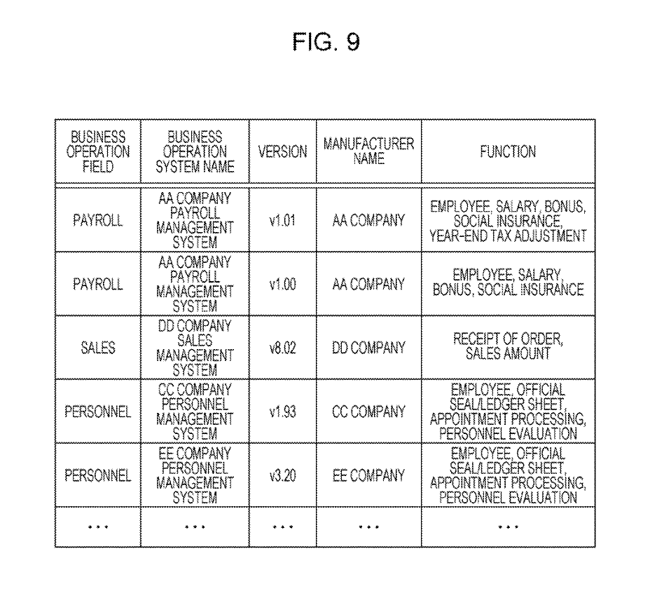

FIG. 9 illustrates an example of the stored business operation system information. In the example of FIG. 9, the business operation system information storage unit 401 stores therein business operation system information in which a business operation field “PAYROLL”, a business operation system name “AA COMPANY PAYROLL MANAGEMENT SYSTEM”, a business operation system version “v1.01”, a manufacturer name “AA COMPANY”, and functions “EMPLOYEE, SALARY, BONUS, SOCIAL INSURANCE, YEAR-END TAX ADJUSTMENT” are associated with one another.

In addition, the business operation system information storage unit 401 stores therein business operation system information in which “PAYROLL”, “AA COMPANY PAYROLL MANAGEMENT SYSTEM”, “v1.00”, “AA COMPANY”, and “EMPLOYEE, SALARY, BONUS, SOCIAL INSURANCE” are associated with one another, business operation system information in which “SALES”, “DD COMPANY SALES MANAGEMENT SYSTEM”, “v8.02”, “DD COMPANY”, and “RECEIPT OF ORDER, SALES AMOUNT” are associated with one another, business operation system information in which “PERSONNEL”, “CC COMPANY PERSONNEL MANAGEMENT SYSTEM”, “v1.93”, “CC COMPANY”, and “EMPLOYEE, OFFICIAL SEAL/LEDGER SHEET, APPOINTMENT PROCESSING, PERSONNEL EVALUATION” are associated with one another, and business operation system information in which “PERSONNEL”, “EE COMPANY PERSONNEL MANAGEMENT SYSTEM”, “v3.20”, “EE COMPANY”, and “EMPLOYEE, OFFICIAL SEAL/LEDGER SHEET, APPOINTMENT PROCESSING, PERSONNEL EVALUATION” are associated with one another.

As described above, the business operation system information storage unit 401 stores therein pieces of business operation system information that relate to the same system (“AA COMPANY PAYROLL MANAGEMENT SYSTEM” in the example of FIG. 9) but are different in terms of a version and pieces of business operation system information that are the same in terms of business operation field and functions but are different in terms of a manufacturer (“CC COMPANY PERSONNEL MANAGEMENT SYSTEM” and “EE COMPANY PERSONNEL MANAGEMENT SYSTEM” in the example of FIG. 9). The function list display unit 402 displays a list of functions offered in the information processing system 1 by referring to the business operation system information stored in the business operation system information storage unit 401. The function list display unit 402 displays a list of functions, for example, on a management screen on which a work manager selects a function for which a work request is to be made.

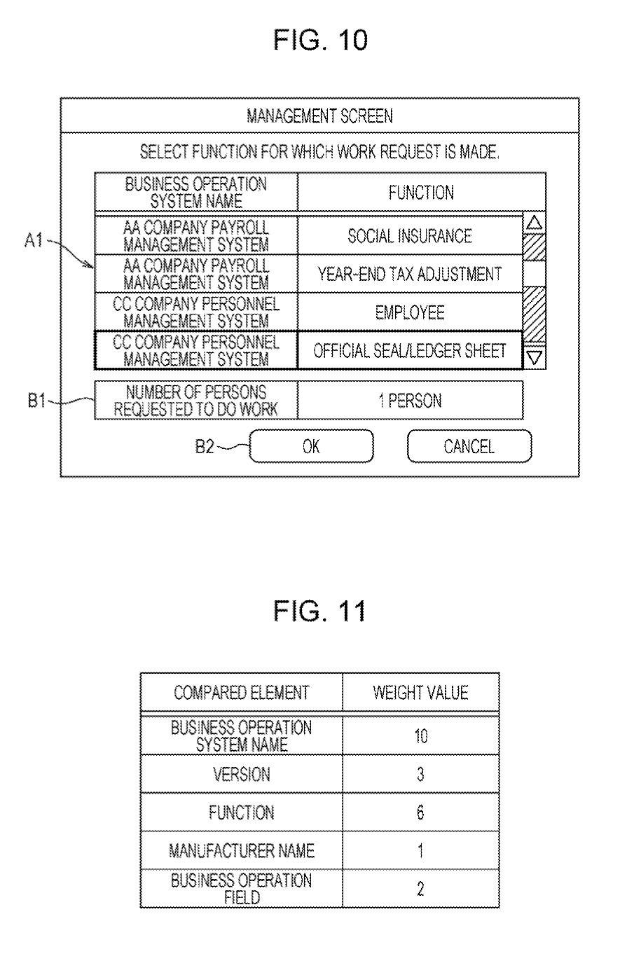

FIG. 10 illustrates an example of the displayed management screen. In the example of FIG. 10, a text “SELECT FUNCTION FOR WHICH WORK REQUEST IS MADE.”, a function list A1 including business operation system names and functions, an edit box B1 for input of the number of workers, an OK button B2, and a cancel button are displayed. In this example, a function “OFFICIAL SEAL/LEDGER SHEET” of “CC COMPANY PERSONNEL MANAGEMENT SYSTEM” included in the function list A1 is selected, and “1 PERSON” is input as the number of persons who is requested to do work. When the OK button B2 is pressed in this state, the designating operation accepting unit 403 accepts this operation as an operation designating a function and the number of persons and notifies the function/number-of-persons designating unit 404 about the function selected and the number of persons input at the time of acceptance of the operation. In the present exemplary embodiment, it is assumed that the selected function is a function of a business operation system of a latest version.

The function/number-of-persons designating unit 404 designates any of plural functions offered by the information processing system 1 on the basis of a user (work manager)'s operation accepted by the designating operation accepting unit 403. The function/number-of-persons designating unit 404 is an example of a “designating unit” of the present invention. A function designated by the function/number-of-persons designating unit 404 is a function for which a work request is to be made to any of workers by the work manager and is hereinafter referred to as a “target function”.

The function/number-of-persons designating unit 404 designates, as a target function, a function (“OFFICIAL SEAL/LEDGER SHEET” of “CC COMPANY PERSONNEL MANAGEMENT SYSTEM” in the example of FIG. 10) notified by the designating operation accepting unit 403. Furthermore, the function/number-of-persons designating unit 404 designates the number of workers who do work on the designated function on the basis of a work manager's operation. The function/number-of-persons designating unit 404 designates, as the number of workers, the number of persons (“1 PERSON” in the example of FIG. 10) notified by the designating operation accepting unit 403. The function/number-of-persons designating unit 404 supplies information (e.g., a function ID allocated to each function) for identifying the target function thus designated to the function similarity calculating unit 405, the worker specifying unit 406, and the support material extracting unit 412 and supplies number-of-persons information indicative of the designated number of workers to the worker specifying unit 406.

The function similarity calculating unit 405 calculates similarity between the function designated by the function/number-of-persons designating unit 404 and other functions. The function similarity calculating unit 405 calculates the similarity by using a compared element table in which compared elements used for comparison between functions and weight values are associated.

FIG. 11 illustrates an example of the compared element table. In the example of FIG. 11, a weight value “10” is associated with a compared element “BUSINESS OPERATION SYSTEM NAME”. Furthermore, weight values “3”, “6”, “1”, and “2” are associated with “VERSION”, “FUNCTION”, “MANUFACTURER NAME”, and “BUSINESS OPERATION FIELD”, respectively.

For example, when the function “OFFICIAL SEAL/LEDGER SHEET” of “CC COMPANY PERSONNEL MANAGEMENT SYSTEM” and “OFFICIAL SEAL/LEDGER SHEET” of “CC COMPANY PERSONNEL MANAGEMENT SYSTEM” that have a common business operation field and a common function are compared, the function similarity calculating unit 405 obtains 8 (“2”+“6”) as similarity. When “SALARY” of “AA COMPANY PAYROLL MANAGEMENT SYSTEM” of the latest version “v1.01” and “BONUS” of “AA COMPANY PAYROLL MANAGEMENT SYSTEM” of “v1.00” that have a business operation field, a business operation system name, and a manufacturer name in common, the function similarity calculating unit 405 obtains 13 (“2”+“10”+“1”) as similarity. The function similarity calculating unit 405 that has calculated similarity for each of the stored functions by referring to the business operation system information storage unit 401 supplies a result of the calculation to the worker specifying unit 406.

The worker specifying unit 406 specifies a worker who is requested to do work on the basis of the function and the number of persons designated by the function/number-of-persons designating unit 404. First, the worker specifying unit 406 requests the history information acquiring unit 407 to acquire history information including the designated function (of the same business operation system). The history information acquiring unit 407 requests the work history server apparatus 30 to supply the history information requested by the worker specifying unit 406. Upon receipt of this request, the history information extracting unit 302 of the work history server apparatus 30 searches for the requested history information from among history information accumulated in the history information accumulating unit 301.

In cases where one or more pieces of requested history information are found, the history information extracting unit 302 extracts the history information and then transmits the history information to the work manager terminal 40. The history information acquiring unit 407 acquires the history information thus received and supplies the acquired history information to the worker specifying unit 406. In cases where no requested history information is found, the history information extracting unit 302 notifies the work manager terminal 40 about the failure to acquire the requested history information. In such cases, the history information acquiring unit 407 also notifies the worker specifying unit 406 about the failure to acquire the requested history information.

In cases where one or more pieces of history information is supplied from the history information acquiring unit 407 and where the number of user IDs included in the supplied history information is equal to or larger than the designated number of persons, the worker specifying unit 406 specifies users identified by the user IDs as workers. In cases where the number of user IDs is less than the designated number of persons or in cases where the worker specifying unit 406 is notified about failure to find history information, the worker specifying unit 406 requests history information including the designated function of a different business operation system.

In cases where the sum of the number of user IDs included in history information acquired in response to this request and the number of user IDs included in the history information acquired previously is equal to or larger than the designated number of persons, the worker specifying unit 406 specifies users identified by these user IDs as workers. In cases where the designated number of persons is not still reached, the worker specifying unit 406 requests history information including a manufacturer name that is in common with the designated function. In cases where the designated number of persons is not still reached, the worker specifying unit 406 requests history information including a common business operation field.

As described above, the worker specifying unit 406 specifies, as workers, users indicated by history information including a common element that is in common with a designated function, and if the designated number of persons is not reached, the range of the common element is widened in stages until the designated number of persons is reached. The worker specifying unit 406 supplies the user IDs of the workers thus specified and similarities calculated for functions included in work history of these workers to the worker information output unit 408.

The worker information output unit 408 outputs information concerning a user who is shown from history information to have experienced work of operating a function similar to a function designated by the function/number-of-persons designating unit 404 before among plural functions offered by the information processing system 1. The worker information output unit 408 is an example of a “first output unit” of the present invention. Hereinafter, the function that is designated is referred to as a “designated function”, and a function similar to the designated function is referred to as a “similar function”. The designated function is an example of a “first function” of the present invention, and the similar function is an example of a “second function” of the present invention.

In the present exemplary embodiment, as described above, the worker specifying unit 406 widens the range of a similar function that is similar to a designated function until the number of users who are shown from history information to have experienced work of operating the similar function before reaches a determined number of persons (the number of persons designated by the function/number-of-persons designating unit 404). Accordingly, the worker information output unit 408 outputs information concerning the users found in cases where the range of the similar function is widened until the number of users reaches the predetermined number of persons.

The worker information output unit 408 supplies user IDs and similarities supplied from the worker specifying unit 406 to the UI unit 46 that is a display of the work manager terminal 40 and causes the UI unit 46 to display the user IDs and the similarities as information concerning users.

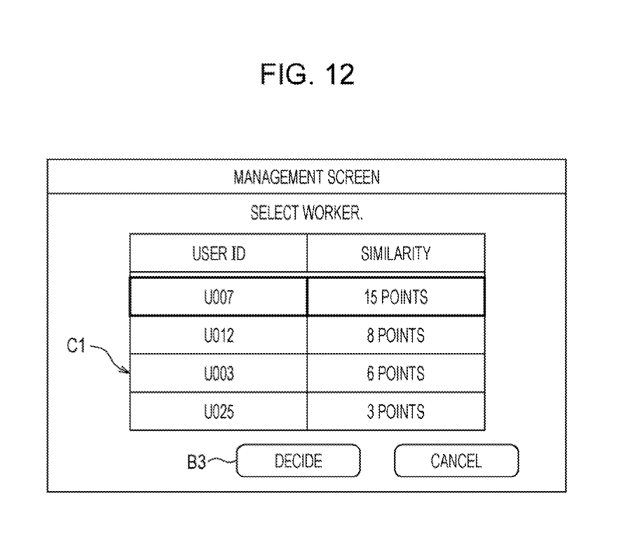

FIG. 12 illustrates an example of the displayed information concerning users. In the example of FIG. 12, the worker information output unit 408 displays, on the management screen, worker information C1 showing a user ID “U007” of a user having a similarity of “15 POINTS”, a user ID “U012” of a user having a similarity of “8 POINTS”, a user ID “U003” of a user having a similarity of “6 POINTS”, and a user ID “U025” of a user having a similarity of “3 POINTS” from the top in the descending order of similarity.

In cases where there are users who have the same similarity, the worker information output unit 408, for example, causes a user who is shown from history information to have experienced a larger number of pieces of work to be displayed higher. Alternatively, in such cases, the worker information output unit 408 may cause a user for whom a smaller number of days have elapsed from a working date to be displayed higher. In either case, a user who is regarded as being better at operating the designated function (a user who has experienced a larger number of pieces of work or a user who has done work more recently) is displayed higher.

When a work manager selects any of the workers from the worker information C1 and presses a decision button C3, the worker deciding operation accepting unit 409 accepts this operation as an operation of deciding a worker. The worker deciding operation accepting unit 409 supplies a user ID of the user decided by the accepted operation to the work request information output unit 413. Furthermore, the worker deciding operation accepting unit 409 supplies history information of the user to the support material extracting unit 412.

The support material acquiring unit 411 acquires a support material for supporting the work of the business operation system. The support material is, for example, a document (a manual or an instruction) or a moving image for explaining how to use the business operation system. The support material acquiring unit 411 acquires, as a support material, document data showing such a document or moving image data showing operation, for example, from an external device in which the document data or the moving image data is stored.

The support material extracting unit 412 extracts a portion corresponding to a difference between the designated function and the similar function from the support material acquired by the support material acquiring unit 411. The support material extracting unit 412 is an example of an “extracting unit” of the present invention. The support material extracting unit 412 extracts this portion by using the function ID of the designated function supplied from the function/number-of-persons designating unit 404, history information supplied from the worker deciding operation accepting unit 409, and a support material table in which functions offered by the business operation system and corresponding portions of a support material are associated.

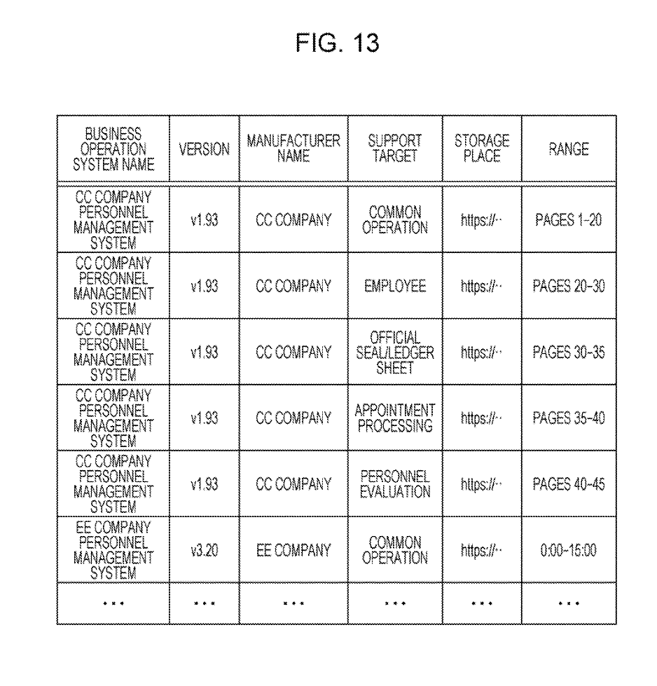

FIG. 13 illustrates an example of the support material table. In this support material table, “BUSINESS OPERATION SYSTEM NAME”, “VERSION”, “MANUFACTURER NAME”, “SUPPORT TARGET”, “STORAGE PLACE”, and “RANGE” are associated. The “SUPPORT TARGET” is a target supported by a support material. The support target includes not only functions such as “EMPLOYEE” and “OFFICIAL SEAL/LEDGER SHEET”, but also an operation referred to as a “COMMON OPERATION” that is common to all functions.

The common operation is, for example, an operation of selecting a function from a menu, an operation of accessing a database, or an operation of redoing processing. The “STORAGE PLACE” is a path (a uniform resource locator (URL) in this example) to a place where a support material such as document data or moving image data is stored. The “RANGE” is a range of pages of a document or a range of a reproduction time of a moving image on which a support target shown in this table is mentioned.

For example, when the designated function is “OFFICIAL SEAL/LEDGER SHEET” of a latest version of “CC COMPANY PERSONNEL MANAGEMENT SYSTEM” and a function shown by supplied history information is “OFFICIAL SEAL/LEDGER SHEET” of a latest version of “EE COMPANY PERSONNEL MANAGEMENT SYSTEM”, the support material extracting unit 412 first requests document data of the latest version (v1.93) of “CC COMPANY PERSONNEL MANAGEMENT SYSTEM” from the support material acquiring unit 411, and the support material acquiring unit 411 acquires this document data from a storage place.

In this case, a difference is a manufacturer of a business operation system, and a user who has done work shown by the history information has not experienced a common operation of the CC company personnel management system before. Therefore, the support material extracting unit 412 extracts, as support materials, a range (pages 1 to 20) associated with “COMMON OPERATION” of “CC COMPANY PERSONNEL MANAGEMENT SYSTEM” in addition to a range (pages 30 to 35) associated with “OFFICIAL SEAL/LEDGER SHEET” of “CC COMPANY PERSONNEL MANAGEMENT SYSTEM” from the acquired document data.

When the designated function is “OFFICIAL SEAL/LEDGER SHEET” of the latest version of “CC COMPANY PERSONNEL MANAGEMENT SYSTEM” and a function shown by supplied history information is “APPOINTMENT PROCESSING” of the latest version of “CC COMPANY PERSONNEL MANAGEMENT SYSTEM”, the support material extracting unit 412 extracts, as a support material, only the range (pages 30 to 35) associated with “OFFICIAL SEAL/LEDGER SHEET” of “CC COMPANY PERSONNEL MANAGEMENT SYSTEM” since a manufacturer of a business operation system is common and a difference is a function only and a user who has done work shown by the history information has already experienced the common operation of the CC company personnel management system. The support material extracting unit 412 supplies the support material thus extracted to the work request information output unit 413 together with the function ID of the designated function.

The work request information output unit 413 outputs work request information that is information for request of work to a worker on the basis of the user ID supplied from the worker deciding operation accepting unit 409 and the support material and the function ID supplied from the support material extracting unit 412. The work request information output unit 413 outputs, as the work request information, information including information showing a document used for the designated function indicated by the supplied function ID, information showing an image for operation that accepts an operation of processing performed by the designated function, and information showing a portion of a support material extracted by the support material extracting unit 412. The work request information output unit 413 is an example of a “second output unit” of the present invention, and the work request information is an example of “information for work” of the present invention.

The work manager terminal 40 stores therein a destination table in which destination information (e.g., Internet protocol (IP) address) of the worker terminals 20 and user IDs are associated, and the work request information output unit 413 supplies the work request information to a destination associated with the supplied user ID in this destination table. The business operation screen display unit 201 of the destination worker terminal 20 displays, as a business operation screen, a screen for requesting a user (worker) who uses the worker terminal 20 to do work on the basis of the supplied work request information.

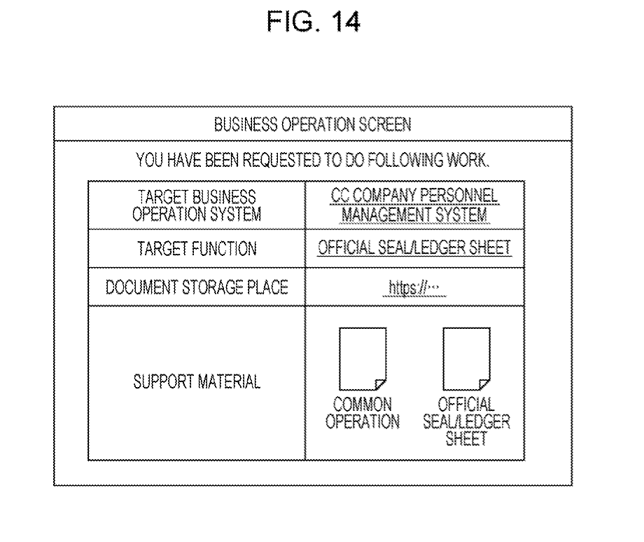

FIG. 14 is an example of the displayed business operation screen. In the example of FIG. 14, the business operation screen display unit 201 displays a link to “CC COMPANY PERSONNEL MANAGEMENT SYSTEM” that is the target business operation system, a link to “OFFICIAL SEAL/LEDGER SHEET” that is the target function, a link to “http:// . . . ” that is a document storage place, a link to a support material for “COMMON OPERATION”, and a link to a support material for “OFFICIAL SEAL/LEDGER SHEET”. When the worker presses these links, screens displaying the business operation system and the function for which a work request has been made, a document on which work is to be done, and a support material are displayed. The worker does the requested work while watching the displayed screens, document, and support material.

The worker terminal 20, the work history server apparatus 30, and the work manager terminal 40 perform work request processing for requesting a worker decided by a worker manager to do work on the basis of the above configuration.

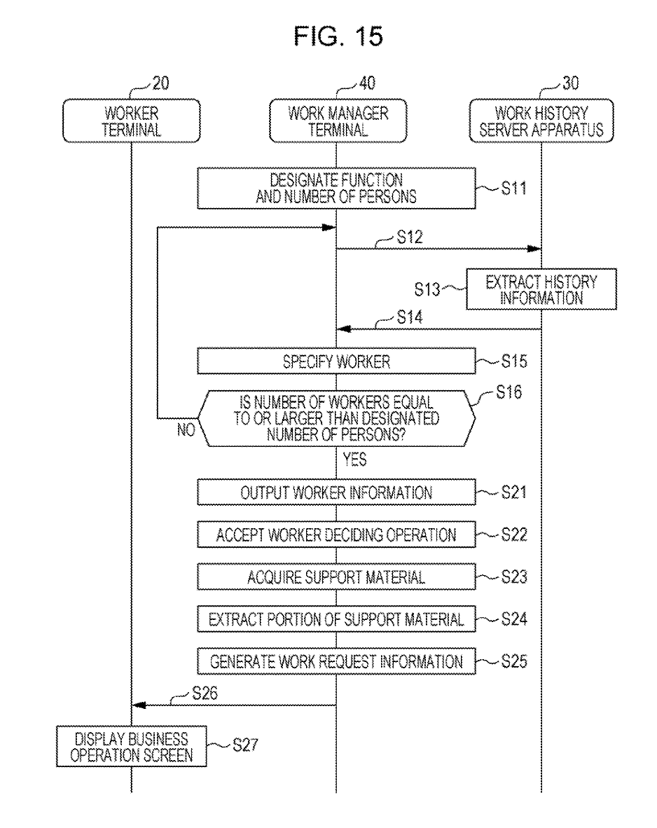

FIG. 15 illustrates an example of an operation procedure of the apparatuses in the work request processing. This operation procedure starts, for example, when a work manager selects a function for which a work request is made and the number of persons on the management screen illustrated in FIG. 10. First, the work manager terminal 40 (the function/number-of-persons designating unit 404) designates a work target function for which a work request is to be made and the number of workers on the basis of an accepted operation (Step S11).

Next, the work manager terminal 40 (the worker specifying unit 406 and the history information acquiring unit 407) requests history information including the designated function from the work history server apparatus 30 (Step S12). The work history server apparatus 30 (the history information extracting unit 302) extracts the requested history information from among history information accumulated therein (Step S13) and then transmits the requested history information to the work manager terminal 40 (Step S14). The work manager terminal 40 (the worker specifying unit 406 and the history information acquiring unit 407) acquires the history information in Step S14 and specifies, as a worker, a user indicated by the acquired history information (Step S15).

The work manager terminal 40 determines whether or not the number of specified workers is equal to or larger than the number of persons designated in Step S11 (Step S16). In cases where the work manager terminal 40 determines that the number of specified workers is less than the designated number of persons (NO), the processing returns to Step S12. In cases where the work manager terminal 40 determines in Step S16 that the number of specified workers is equal to or larger than the designated number of persons (YES), the work manager terminal 40 (the worker information output unit 408) supplies worker information indicative of the specified workers to a display thereof (Step S21). Next, the work manager terminal 40 (the worker deciding operation accepting unit 409) accepts an operation of deciding a worker who is actually requested to do work from among the workers indicated by the worker information (Step S22).

Subsequently, the work manager terminal 40 (the support material acquiring unit 411) acquires a support material for supporting work of the decided worker (Step S23). Next, the work manager terminal 40 (the support material extracting unit 412) extracts a portion for supporting the worker's work from the acquired support material (Step S24). Subsequently, the work manager terminal 40 (the work request information output unit 413) generates work request information including a document and an image for operation used for the designated function and the extracted support material (Step S25), and then transmits the work request information to the worker terminal 20 of the worker decided in Step S22 (Step S26). The worker terminal 20 (the business operation screen display unit 201) displays a business operation screen on the basis of the received work request information (Step S27).

In the present exemplary embodiment, information concerning a user who has an experience of doing work on a similar function that is similar to a designated function designated by a work manager is output as in the example of FIG. 12. Even if there is no user who has an experience of doing work on the designated function, information concerning a user who is capable of properly carrying out the work which he or she has not experienced before (a user who is regarded to be capable of doing the work better than other users) is output. This helps the work manager find such a user. Furthermore, in the present exemplary embodiment, work request information including information showing a document used for the designated function and information showing an image for operation is output. This saves the trouble of searching for such a document and an image for operation, thereby allowing a user to operate the designated function with less trouble than in cases where the work request information is not output.

Furthermore, in the present exemplary embodiment, work request information including information showing a portion of a support material is output. This portion is a portion of the support material that corresponds to a difference between the designated function and the similar function, i.e., contents that support work which a worker has not experienced before. This allows the worker to more easily operate the designated function than in cases where the work request information is not output. Furthermore, in the present exemplary embodiment, the range of similarity is widened until the number of specified workers reaches a designated number of persons. As a result, a necessary number of users who are capable of properly carrying out work which they have not experienced before are found.

### [2] Modifications

The above exemplary embodiment is merely an example of the present invention and may be modified as follows. The exemplary embodiment and the modifications may be combined as needed.

### [2-1] Support Material Extracting Unit

A method for extracting a portion from a support material by the support material extracting unit 412 is not limited to the method described in the exemplary embodiment. For example, when the official seal/ledger sheet function of the CC company personnel management system is a designated function and a personnel evaluation function is a similar function in the example of FIG. 13, the support material extracting unit 412 need just extract a range (pages 30 to 35) that supports work on “OFFICIAL SEAL/LEDGER SHEET” without extracting a range (pages 1 to 20) that supports a common operation.

Furthermore, in cases where a difference between a designated function and a similar function is a version, pages of a document or a time of a moving image on which a function added in a new version is mentioned may be associated with “RANGE” of the support material table, and the support material extracting unit 412 may extract the range concerning the added function. Furthermore, in cases where a difference between a designated function and a similar function is a manufacturer name, pages of a document or a time of a moving image on which a function unique to a manufacturer is mentioned may be associated with “RANGE” of the support material table, and the support material extracting unit 412 may extract the range concerning the unique function. In each case, a portion that mentions contents supporting work which a worker has not experienced before is extracted from a support material. This allows the worker to easily operate the designated function as in the exemplary embodiment.

### [2-2] Designation of Plural Functions

The function/number-of-persons designating unit 404 may designate plural functions. For example, in cases where the OK button B2 is pressed while two functions “SOCIAL INSURANCE” and “YEAR-END TAX ADJUSTMENT” are being selected from the function list A1 illustrated in FIG. 10, the function/number-of-persons designating unit 404 designates these two functions.

In this case, the worker specifying unit 406 need just specify, as a worker, a user indicated by history information including an element common to the functions. For example, in cases where a work manager requests two users to work, the work manager need just select one user who is capable of properly carrying out work on “SOCIAL INSURANCE” and one user who is capable of properly carrying out work on “YEAR-END TAX ADJUSTMENT”. Even if the work manager requests one user to work, one user who is capable of more properly carrying out work on both of the two functions than other users is selected, for example, by comparing the sum of similarities calculated for the respective functions.

### [2-3] Division of Work

In cases where work of operating a designated function includes plural pieces of work, plural workers may do the respective plural pieces of work. In the present modification, in cases where there are plural users who are shown from history to have experienced work of operating a similar function, the work request information output unit 413 divides work request information into parts corresponding to the respective pieces of work of operating the designated function which the plural users are in charge of.

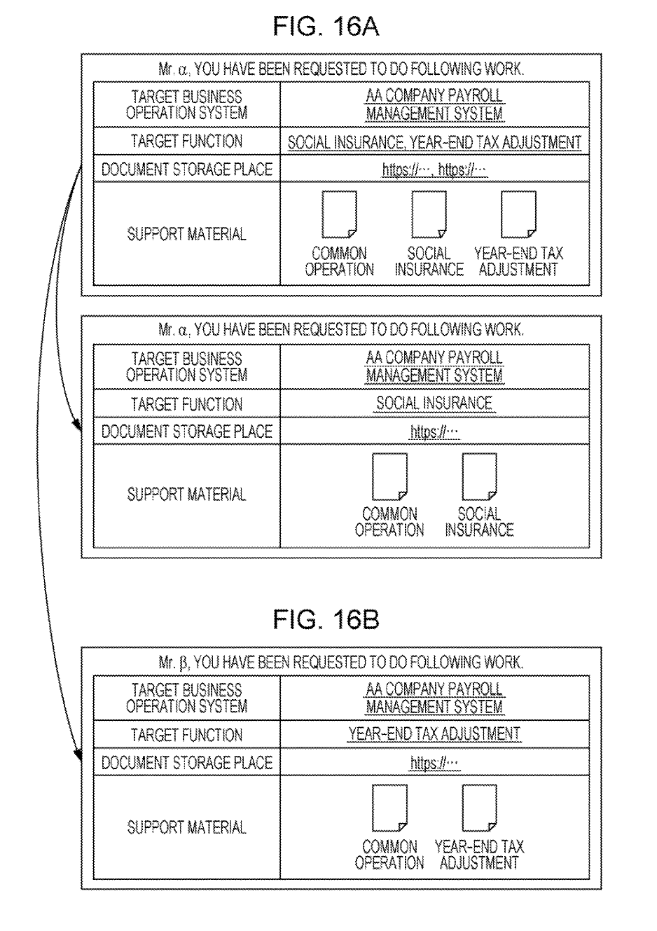

FIGS. 16A and B illustrate an example of the output work request information. FIG. 16A illustrates an example in which work request information requesting work of operating plural designated functions is supplied to the worker terminal 20 of a single user. In this example, the work request information output unit 413 outputs, as work request information, a text “Mr. α, YOU HAVE BEEN REQUESTED TO DO FOLLOWING WORK”, two target functions “SOCIAL INSURANCE” and “YEAR-END TAX ADJUSTMENT” of “AA COMPANY PAYROLL MANAGEMENT SYSTEM”, storage places in which documents for the respective functions are stored, and support materials that mention “COMMON OPERATION”, “SOCIAL INSURANCE”, and “YEAR-END TAX ADJUSTMENT”.

FIG. 16B illustrates an example in which first work request information and second work request information obtained by dividing the work request information illustrated in FIG. 16A into two parts are supplied to the worker terminals 20 of two users. In this example, the work request information output unit 413 outputs, as the first work request information, a text “Mr. α, YOU HAVE BEEN REQUESTED TO DO FOLLOWING WORK”, a single target function “SOCIAL INSURANCE” of “AA COMPANY PAYROLL MANAGEMENT SYSTEM”, a storage place in which a document for the function is stored, and support materials that mention “COMMON OPERATION” and “SOCIAL INSURANCE”.

The work request information output unit 413 outputs, as the second work request information, a text “Mr. β, YOU HAVE BEEN REQUESTED TO DO FOLLOWING WORK”, a single function “YEAR-END TAX ADJUSTMENT” of “AA COMPANY PAYROLL MANAGEMENT SYSTEM”, a storage place in which a document for the function is stored, and support materials that mention “COMMON OPERATION” and “YEAR-END TAX ADJUSTMENT”. In cases where divided work request information is output, each of workers who have been entrusted with respective pieces of work receives only information concerning work which he or she is in charge of. This saves the worker the trouble of searching for information related to him or her. Consequently, each user who is in charge of a divided part of work does his or her part of work with less trouble than in cases where work request information is not divided.

The way in which work request information is divided is not limited to the one described above. For example, in cases where the work request information output unit 413 divides work request information requesting work of operating a single designated function, the work may be separated into plural pieces of work, and names of the pieces of work which respective workers are in charge of may be included in divided pieces of work request information. In cases where these pieces of work are done in order, the work request information output unit 413 may cause a name of a next worker to be included in each divided piece of work request information. That is, the work request information output unit 413 may output any information as long as this information supports work of each worker who is in charge of a divided part of work.

### [2-4] Operation Authority

As for functions offered by a business operation system, an authority of operating the functions is sometimes set. In cases where a function for which an operation authority is set is designated by the function/number-of-persons designating unit 404, the worker information output unit 408 may output information concerning a user who is shown from history to have done work of operating a similar function before and who has an authority of operating the function.

In this case, for example, the work manager terminal 40 stores therein an operation authority table in which function IDs of functions and user IDs of users having an operation authority of the functions are associated.

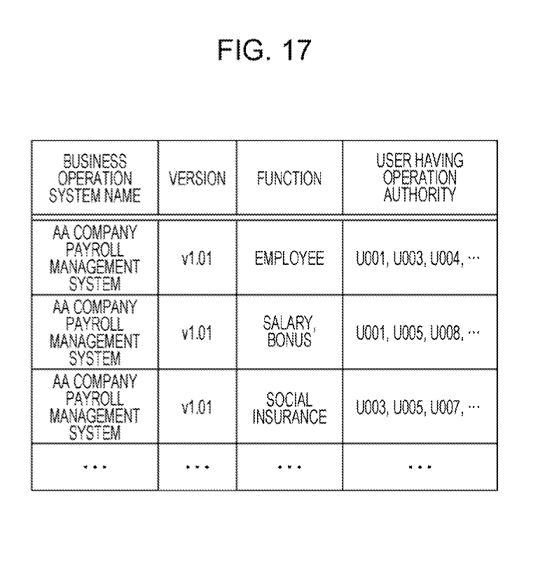

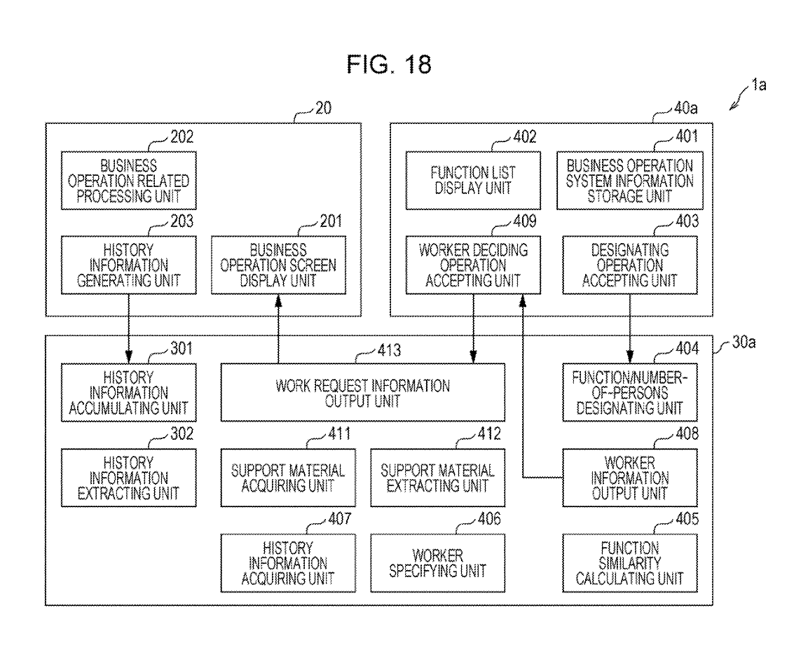

FIG. 17 illustrates an example of an operation authority table. In the example of FIG. 17, user IDs “I001, U003, U004, . . . ” of users having an operation authority are associated with the function “EMPLOYEE” of “v1.01” of “AA COMPANY PAYROLL MANAGEMENT SYSTEM”. Furthermore, user IDs of users having an operation authority are also associated with functions “SALARY, BONUS” and “SOCIAL INSURANCE”.

In the present modification, for example, the worker specifying unit 406 supplies a function ID of a designated function to the worker information output unit 408 together with user IDs of specified users, and the worker information output unit 408 outputs information concerning a user indicated by a user ID associated with a function indicated by the supplied function ID in the operation authority table among the supplied user IDs. In this way, information concerning a user who has an operation authority of the designated function is output. Note, however, that the present modification is not limited to this. The worker specifying unit 406 may exclude users who have not an operation authority by referring to the operation authority table when specifying users. In either case, only a user who has an operation authority is found by output information concerning the user.

### [2-5] Method for Specifying Worker

The worker specifying unit 406 may specify a worker who is requested to do work by a method different from the method of the exemplary embodiment. The worker specifying unit 406 may, for example, request history information including function IDs of functions in the descending order of similarity on the basis of a result of calculation of similarity supplied from the function similarity calculating unit 405 and specify a worker by repeating the request until the number of users indicated by history information acquired in response to the request becomes equal to or larger than a designated number of persons.

### [2-6] Method for Deciding Worker

In the exemplary embodiment, a worker who is requested to do work is decided by an operation accepted by the worker deciding operation accepting unit 409. However, a method for deciding a worker is not limited to this. For example, a worker indicated by worker information output by the worker information output unit 408 may be decided as a worker who is requested to do work. In this case, the number of decided workers may be larger than the designated number of persons, and if the number of decided workers is larger than the designated number of persons, the worker information output unit 408 may output worker information excluding an excess number of workers.

[2-7] Apparatus that Realize Functions

An apparatus different from the one described above may realize the functions, for example, illustrated in FIG. 6.

FIG. 18 is a functional configuration realized by an information processing system 1a according to the present modification. The information processing system 1a includes a worker terminal 20, a work history server apparatus 30a, and a work manager terminal 40a. The work history server apparatus 30a includes a function/number-of-persons designating unit 404, a function similarity calculating unit 405, a worker specifying unit 406, a history information acquiring unit 407, a worker information output unit 408, a support material acquiring unit 411, a support material extracting unit 412, and a work request information output unit 413 in addition to the units illustrated in FIG. 6.

In this way, except for a function of accepting an operation of a work manager and a function of displaying information, which are left to the work manager terminal, other functions such as designation of a function and the number of workers, specifying of a worker, output of worker information, and output of work request information may be realized by another apparatus (the work history server apparatus 30a in this case). In the example of FIG. 18, the work history server apparatus 30a is an example of an “information processing apparatus” of the present invention. Alternatively, functions from the function/number-of-persons designating unit 404 to the worker information output unit 408 and functions from the support material acquiring unit 411 to the work request information output unit 413 may be realized by another apparatus different from the work history server apparatus. In this case, the “other apparatus” that realizes these functions is an example of an “information processing apparatus” of the present invention.

### [2-8] Categories of Invention

The present invention can be regarded not only as an information processing apparatus such as a work manager terminal, a work history server apparatus, a worker terminal, or a business operation server apparatus, but also as an information processing system including these apparatuses or as an information processing system that includes another group of apparatuses that realize the function, for example, illustrated in FIG. 6. Furthermore, the present invention can also be regarded as an information processing method for realizing processes performed by the apparatuses or a program for causing a computer that controls the apparatuses to function. This program may be provided in the form of a recording medium such as an optical disc in which the program is stored or may be provided in a manner such that the program is downloaded and installed into a computer over a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a designating unit that designates a first function from among a plurality of functions on a basis of a user's operation in a case where a history of work of operating one or more business operation systems having the plurality of functions is accumulated; and
a first output unit that outputs information concerning a user who is shown from the history to have experienced work of operating a second function before, the second function being similar to the first function designated from among the plurality of functions.

2. The information processing apparatus according to claim 1, further comprising a second output unit that outputs information for work including information showing a document used for the first function and information showing an image for operation that accepts an operation concerning processing performed by the first function.

3. The information processing apparatus according to claim 2, further comprising an extracting unit that extracts a portion corresponding to a difference between the first function and the second function from a material for supporting work of operating the one or more business operation systems,
wherein the second output unit outputs the information for work additionally including information showing the extracted portion.

4. The information processing apparatus according to claim 2, wherein
work of operating the first function includes a plurality of pieces of work, and
in a case where there are a plurality of users who are shown from the history to have experienced the work of operating the second function before, the second output unit divides the information for work into parts corresponding to the respective plurality of pieces of work which the respective plurality of users are in charge of.

5. The information processing apparatus according to claim 3, wherein
work of operating the first function includes a plurality of pieces of work, and
in a case where there are a plurality of users who are shown from the history to have experienced the work of operating the second function before, the second output unit divides the information for work into parts corresponding to the respective plurality of pieces of work which the respective plurality of users are in charge of.

6. The information processing apparatus according to claim 1, wherein
au authority of operating the first function is set, and
the first output unit outputs information concerning a user who is shown from the history to have experienced the work of operating the second function before and who has the authority.

7. The information processing apparatus according to claim 2, wherein
au authority of operating the first function is set, and
the first output unit outputs information concerning a user who is shown from the history to have experienced the work of operating the second function before and who has the authority.

8. The information processing apparatus according to claim 3, wherein
au authority of operating the first function is set, and
the first output unit outputs information concerning a user who is shown from the history to have experienced the work of operating the second function before and who has the authority.

9. The information processing apparatus according to claim 4, wherein
au authority of operating the first function is set, and
the first output unit outputs information concerning a user who is shown from the history to have experienced the work of operating the second function before and who has the authority.

10. The information processing apparatus according to claim 5, wherein
au authority of operating the first function is set, and
the first output unit outputs information concerning a user who is shown from the history to have experienced the work of operating the second function before and who has the authority.

11. The information processing apparatus according to claim 1, wherein
the first output unit outputs, until the number of users who are shown from the history to have experienced the work of operating the second function before reaches a determined number of persons, information concerning the user who is shown from the history to have experienced the work of operating the second function before when the user is found in a case where a range of the second function similar to the first function is widened.

12. A non-transitory computer readable medium storing a program causing a computer to execute a process for information processing, the process comprising:
designating a first function from among a plurality of functions on a basis of a user's operation in a case where a history of work of operating one or more business operation systems having the plurality of functions is accumulated; and
outputting information concerning a user who is shown from the history to have experienced work of operating a second function before, the second function being similar to the first function designated from among the plurality of functions.
